(19) United States
(12) Patent Application Publication
(10) Pub. No.: US 2015/0356599 A1
(43) Pub. Date: Dec. 10, 2015

(54) METHOD AND SYSTEM FOR SENDING EMAIL MESSAGES BASED ON WEATHER

(71) Applicant: YESMAIL INTERACTIVE, Portland, OR (US)

(72) Inventor: Jason WARNOCK, Portland, OR (US)

(21) Appl. No.: 14/301,092

(22) Filed: Jun. 10, 2014

(51) Int. Cl. G06Q 30/02

(52) U.S. Cl. CPC G06Q 30/0252; G06Q 30/0269

(57) ABSTRACT

A method and system is provided for sending email messages based on weather. The method includes initiating a set of conditions for sending one or more marketing messages. The method further includes adding one or more weather conditions to the set of conditions, where the one or more weather conditions are selected from a plurality of weather conditions. Further, the method includes providing one or more locations, where the one or more locations have the selected one or more weather conditions present. Further, the method includes adding at least one location of the one or more locations to the set of conditions. Still further, the method includes associating the one or more marketing messages to the set of conditions. Finally, the method includes sending at least one marketing message of the one or more email messages, where the at least one marketing message is sent when the set of conditions are met.

### BACKGROUND OF THE INVENTION

1. Field of the Invention

The present invention relates to email marketing in general. More specifically, the present invention relates to a method and system for sending email messages based on weather.

2. Background

Email messaging is one of the most powerful and cost-effective mediums for marketing and driving customer engagement. Being cost-effective, most marketers have email-marketing in their marketing plans. It is also no wonder that marketers use e-mail to indiscriminately send messages to e-mail accounts accessible over the Internet. So, users tend to receive a lot of daily marketing emails. Therefore, unless an email is highly targeted and relevant to a user, the tendency of the user is to either delete it or mark it as spam. Ensuring relevance of marketing messaging and providing dynamic content are among the biggest pain points for marketers everywhere.

One of the major factors that impacts both relevance and content in many industries, is weather. People today are time constrained, increasingly fragmented and very dependent on weather conditions. In general, people need help to make the most out of the limited time they have and to improve the quality of their decision making. In fact, the effects of the weather impact all aspects of human endeavour. Based on the forecasted weather, a user's planned event like in-store visit will be affected. Thus, the ability to tailor marketing communications based on weather conditions can greatly enhance the relevance of the message and significantly improve engagement and, consequently, conversions.

In the light of the foregoing discussion, there is a need for a method and system that can send targeted messages to users by taking weather conditions into consideration. Also, there is a need for a method and system for sending email messages based on weather.

### SUMMARY

Accordingly, it is an object of the present invention to provide a method and system for providing a facility to marketers to target users based on weather conditions.

Accordingly, it is another object of the present invention to provide a method and system for providing a facility to marketers to send relevant messages to users based on real-time weather statistics for their recipients' geographic location.

Accordingly, it is yet another object of the present invention to provide a method and system for sending messages to users based on weather via email. The above and other objects of the present invention are achieved by providing a method and system for sending email messages based on weather. The method includes initiating a set of conditions for sending one or more marketing messages. The method further includes adding one or more weather conditions to the set of conditions, where the one or more weather conditions are selected from a plurality of weather conditions. Further, the method includes providing one or more locations, where the one or more locations have the selected one or more weather conditions present. Further, the method includes adding at least one location of the one or more locations to the set of conditions. Still further, the method includes associating the one or more marketing messages to the trigger. Finally, the method includes sending at least one marketing message of the one or more email messages, where the at least one marketing message is sent when the set of conditions are met.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 shows an environment in which various aspects of the present invention can be practiced.

FIG. 2 shows a block diagram of a system for sending messages based on weather, in accordance with an aspect of the present invention.

FIG. 3 shows a block diagram of a system for sending messages based on weather, in accordance with another aspect of the present invention.

FIG. 4 shows a flow chart of a method for sending messages based on weather, in accordance with an aspect of the present invention.

FIG. 5 shows a flow chart of a method for sending messages based on weather, in accordance with another aspect of the present invention.

FIG. 6a-6e show sample screenshots of a sample use case of the method for sending email messages based on weather, in accordance with an aspect of the present invention.

FIG. 7 shows a table containing examples of sample marketing messages triggered based on different weather triggers, in accordance with an aspect of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of aspects of the present invention.

### DETAILED DESCRIPTION

Before describing in detail the particular method and system for sending email messages based on weather in accordance with an aspect of the present invention, it should be observed that the present invention resides primarily in combinations of method and system components related to communication device of the present invention.

Accordingly, the system components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

The terms “computing device” and “communication device” have been used interchangeably, and refer to computing device which has the capability of communicating or interacting with its users.

A method is provided for sending email messages based on weather, in accordance with an aspect of the present invention. The method includes initiating a set of conditions for sending one or more marketing messages. The method further includes adding one or more weather conditions to the set of conditions, where the one or more weather conditions are selected from a plurality of weather conditions. Further, the method includes providing one or more locations, where the one or more locations have the selected one or more weather conditions present. Further, the method includes adding at least one location of the one or more locations to the set of conditions. Still further, the method includes associating the one or more marketing messages to the trigger. Finally, the method includes sending at least one marketing message of the one or more email messages, where the at least one marketing message is sent when the set of conditions are met.

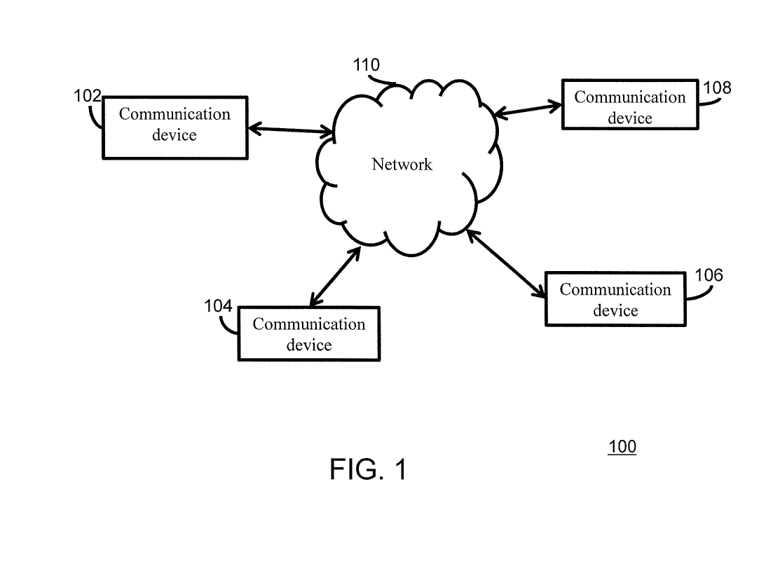

FIG. 1 shows an environment 100 in which various aspects of the present invention can be practised. The environment 100 includes a system connected to a plurality of communication devices 102, 104, 106 & 108 via a network 110. In the present invention, a communication device can be any device capable of communicating through a network. Examples of the plurality of communication devices 102, 104, 106 & 108 include, but are not limited to, a computer, a laptop, a server, a mobile phone, a tablet PC, a netbook, an e-book reader, an embedded computing device and a PDA. The network is one or more of a Wi-Fi network, a cellular network, a 2G network, a 3G network, a 4G network, and an internet network.

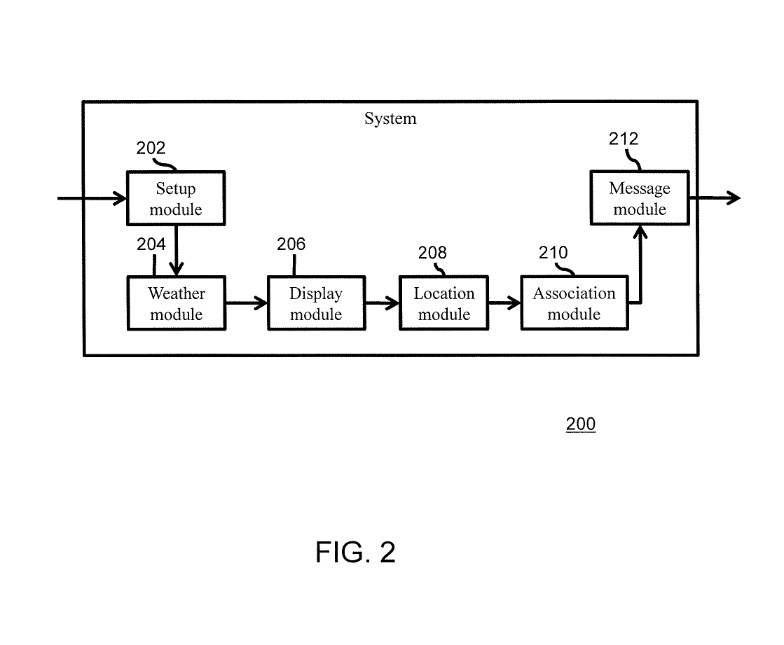

FIG. 2 shows a block diagram of a system 200 for sending messages based on weather, in accordance with an aspect of the present invention. The system 200 includes a setup module 202, a weather module 204, a display module 206, a location module 208, an association module 210 and a message module 212. The setup module 202 initiates a set of conditions for sending one or more marketing messages as part of a trigger. The one or more marketing message can be sent through one of an email, a Short Messaging Service (SMS) message, a push notification, a data message, a website, a web page, a Multimedia Messaging Service (MMS) message, Unstructured Supplementary Service Data (USSD) service, a voice call and a multimedia call. The weather module 204 then adds one or more weather conditions to the set of conditions, where the one or more weather conditions are selected from a plurality of weather conditions. The plurality of weather conditions include one or more of weather type, temperature, precipitation and wind speed. Examples of the weather type include, but are not limited to, rain, snow, freezing rain, hail, fog, mist, smoke, thunderstorm, cloudy, sunny, volcanic activity, hurricane and funnel cloud. In an aspect of the present invention, a user selects range of the one or more weather conditions. For example, temperature between 40° F. and 60° F.

The display module 206 then provides one or more locations, where the one or more locations have the selected one or more weather conditions present. In an aspect of the present invention, the display module 206 displays the list of one or more locations on the display screen of a user. The location module 208 adds at least one location of the one or more locations to the set of conditions. In an aspect of the present invention, the at least one location is selected by the user. The association module 210 then associates the one or more marketing messages to the trigger. In another aspect of the present invention, the one or more marketing messages are composed while associating to the trigger. Finally, the message module 212 sends at least one marketing message of the one or more email messages, where the at least one marketing message is sent when the set of conditions are met.

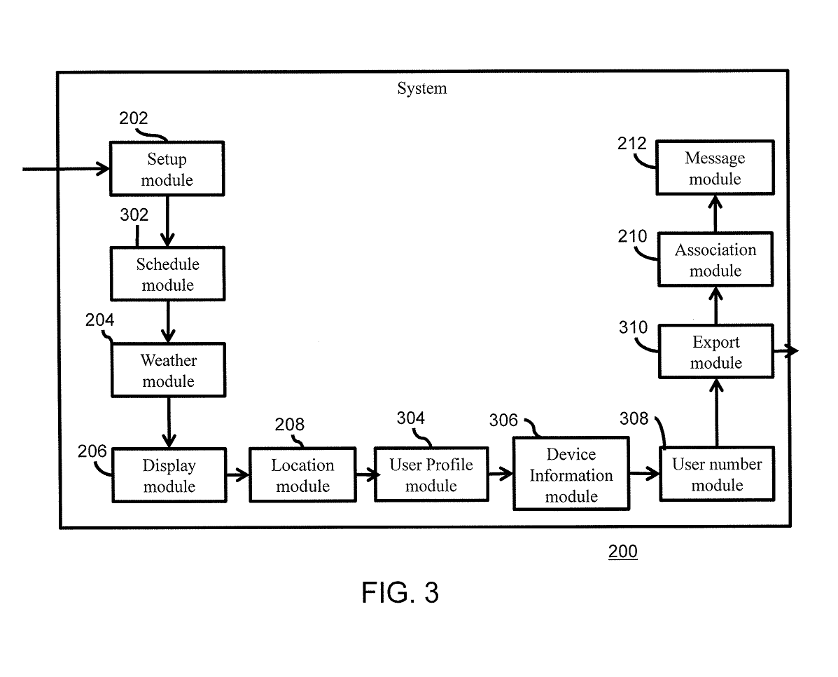

FIG. 3 shows a block diagram of a system 200 for sending messages based on weather, in accordance with another aspect of the present invention. The system 300 includes the setup module 202, a schedule module 302, the weather module 204, the display module 206, the location module 208, a user profile module 304, a device information module 306, a user number module 308, an export module 310 and a message module 212. The setup module 202 initiates a set of conditions for sending one or more marketing messages as part of a trigger based on weather. The one or more marketing message can be sent through one of an email, a Short Messaging Service (SMS) message, a push notification, a data message, a website, a web page, a Multimedia Messaging Service (MMS) message, Unstructured Supplementary Service Data (USSD) service, a voice call and a multimedia call. The schedule module 302 then adds time duration of the campaign to set of conditions. In an aspect of the present invention, the schedule module 302 includes a start schedule module for selecting start time of the trigger. Further, the schedule module 302 includes an end schedule module for selecting end time of the trigger.

The weather module 204 then adds one or more weather conditions to the set of conditions, where the one or more weather conditions are selected from a plurality of weather conditions. The plurality of weather conditions include one or more of weather type, temperature, precipitation and wind speed. Examples of the weather type include, but are not limited to, rain, snow, freezing rain, hail, fog, mist, smoke, thunderstorm, cloudy, sunny, volcanic activity, hurricane and funnel cloud. The display module 206 then provides one or more locations, where the one or more locations have the selected one or more weather conditions present. In an aspect of the present invention, the display module 206 displays the list of one or more locations on the display screen of a user. The location module 208 adds at least one location of the one or more locations to the set of conditions. In an aspect of the present invention, the at least one location is selected by the user. Further, the user profile module 304 adds user profile information to the set of conditions. Examples of the user profile information include, but are not limited to, age group, gender, interests, work place and income group. The device information module 306 further adds device profile information to the set of conditions. Examples of the device profile information include, but are not limited to, one or more of operating system (OS), operative system version, device manufacturer, device model, device network and device screen resolution.

The user number 308 then displays total number of users matching the set of conditions. The total number of users matching the set of conditions is those which are affected by the selected set of conditions. In the present variation, the export module 310 exports the set of conditions to a file. Also, the export module 310 exports the total number of users matching the set of conditions. The file can be in at least one file formats. Examples of the formats include, but are not limited to, CSV (comma separated values), spreadsheet, document, presentation and database.

The association module 210 then associates the one or more marketing messages to the trigger. In another variation of the present invention, the one or more marketing messages are composed while associating to the trigger. Finally, the message module 212 sends at least one marketing message of the one or more email messages, where the at least one marketing message is sent when the set of conditions are met.

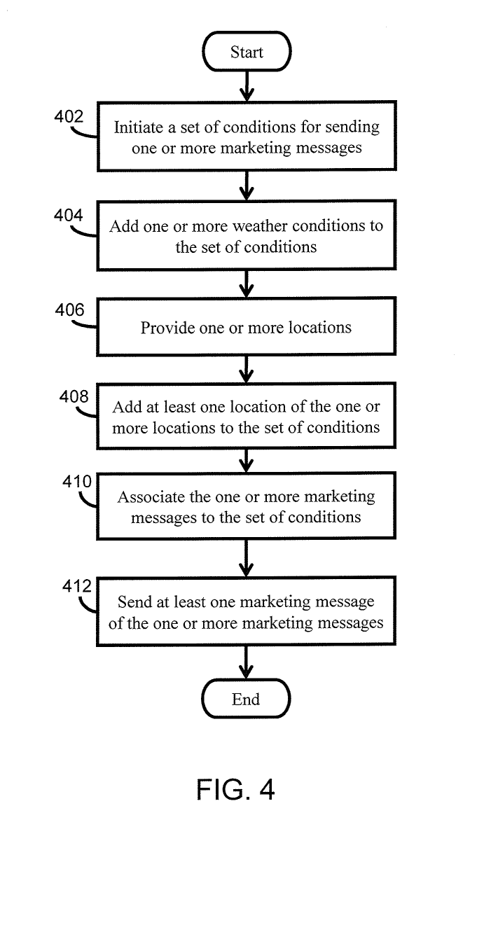

FIG. 4 shows a flow chart of a method for sending messages based on weather, in accordance with an aspect of the present invention. At step 402, the system 200 initiates a set of conditions for sending one or more marketing messages. At step 404, the system 200 adds one or more weather conditions to the set of conditions, where the one or more weather conditions are selected from a plurality of weather conditions. At step 406, the system 200 provides one or more locations, where the one or more locations have the selected one or more weather conditions present. The one or more locations are displayed to a user to make a selection. At step 408, the system adds at least one location of the one or more locations to the set of conditions. In an aspect of the present invention, the at least one location is selected by the user. At step 410, the system 200 associates the one or more marketing messages to the set of conditions. In an aspect of the present invention, associating the one or more marketing messages includes composing the one or more marketing messages while associating. Finally, at step 412, the system 200 sends at least one marketing message of the one or more marketing messages, where the at least one marketing message is sent when the set of conditions are met.

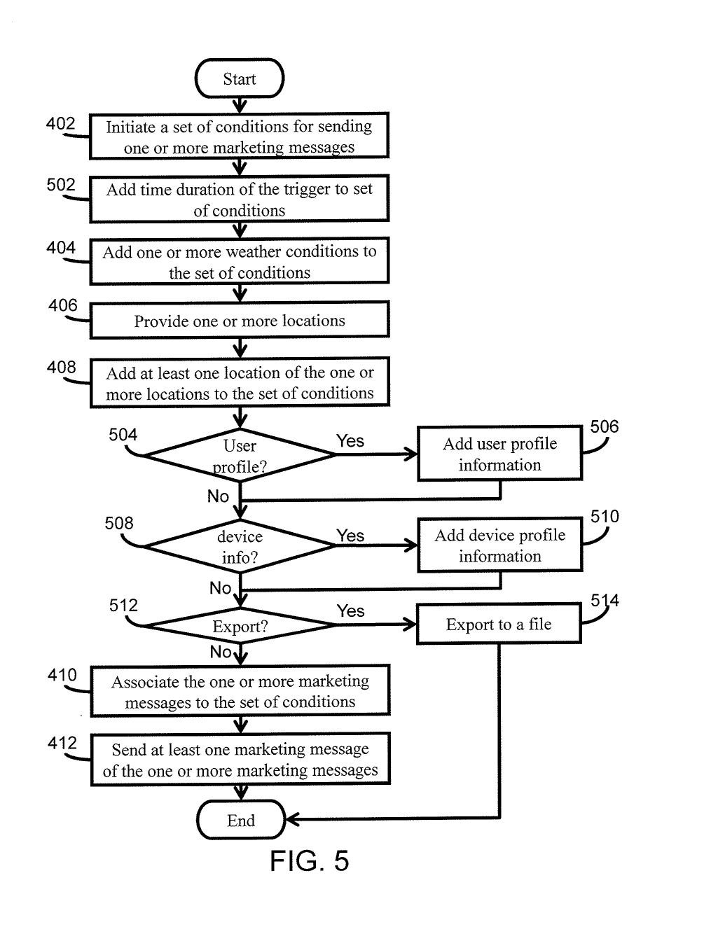

FIG. 5 shows a flow chart of a method for sending messages based on weather, in accordance with another aspect of the present invention. At step 402, the system 200 initiates a set of conditions for sending one or more marketing messages by creating a trigger based on weather. At step 503, the system 200 adds time duration of the trigger to the set of conditions. In an aspect of the present invention, the time duration is added by a user. Adding the time duration includes selecting start time of the trigger. Also, adding the time duration includes selecting end time of the trigger. At step 404, the system 200 adds one or more weather conditions to the set of conditions, where the one or more weather conditions are selected from a plurality of weather conditions. At step 406, the system 200 provides one or more locations, where the one or more locations have the selected one or more weather conditions present during the selected time duration. The one or more locations are displayed to a user to make a selection. At step 408, the system 200 adds at least one location of the one or more locations to the set of conditions. In an aspect of the present invention, the at least one location is selected by the user. At step 504, the system 200 checks if user profile information is to be added to the set of conditions. In an aspect of the present invention, at step 506, the system adds user profile information to the set of conditions. The user profile information includes one or more of age group, gender, interests, work place and income group. At step 508, the system 200 checks if device profile information is to be added to the set of conditions. In an aspect of the present invention, at step 510, the system 200 adds device profile information to the set of conditions. The at least one marketing message is sent to users matching the selected device profile information. The device profile information includes one or more of operating system (OS), operative system version, device manufacturer, device model, device network and device screen resolution.

At step 512, the system 200 provides the option to export the set of conditions of the trigger. In an aspect of the present invention, at step 514, the set of conditions are exported to a file. In another aspect of the present invention, at step 410, the system 200 associates the one or more marketing messages to the set of conditions. In an aspect of the present invention, associating the one or more marketing messages includes composing the one or more marketing messages while associating. Finally, at step 412, the system 200 sends at least one marketing message of the one or more marketing messages, where the at least one marketing message is sent when the set of conditions are met.

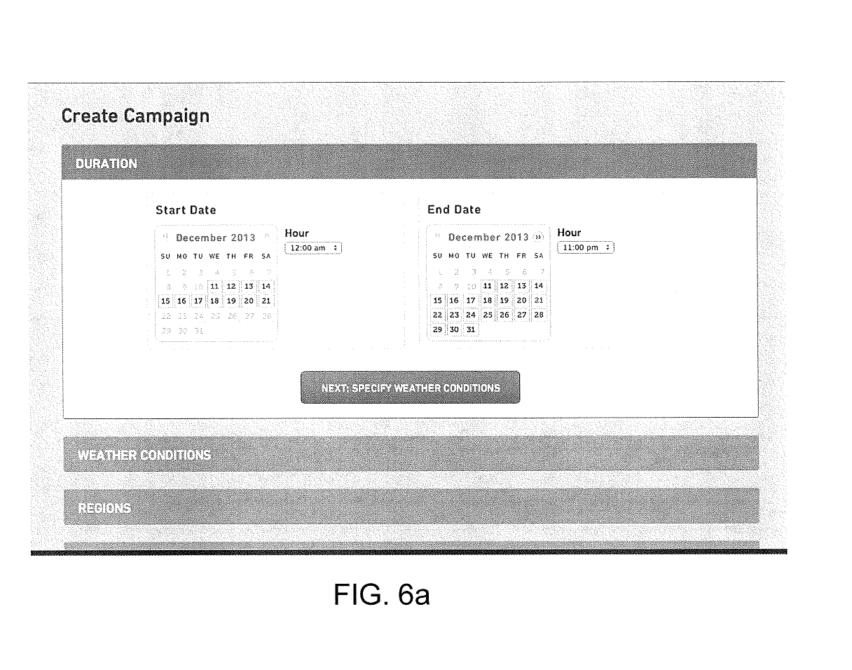

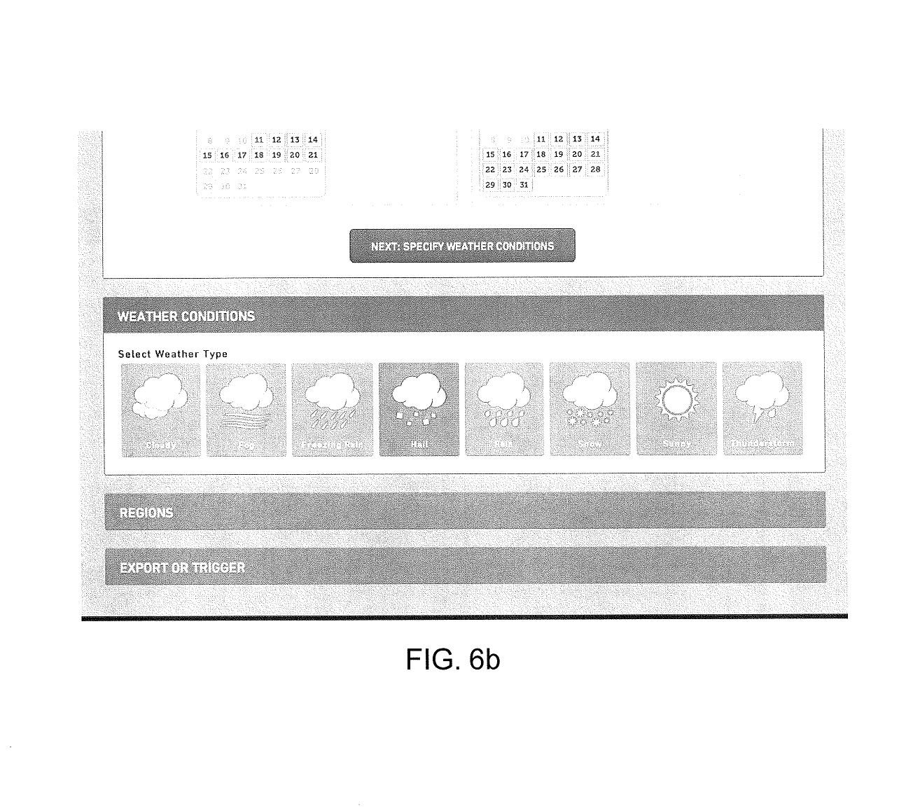

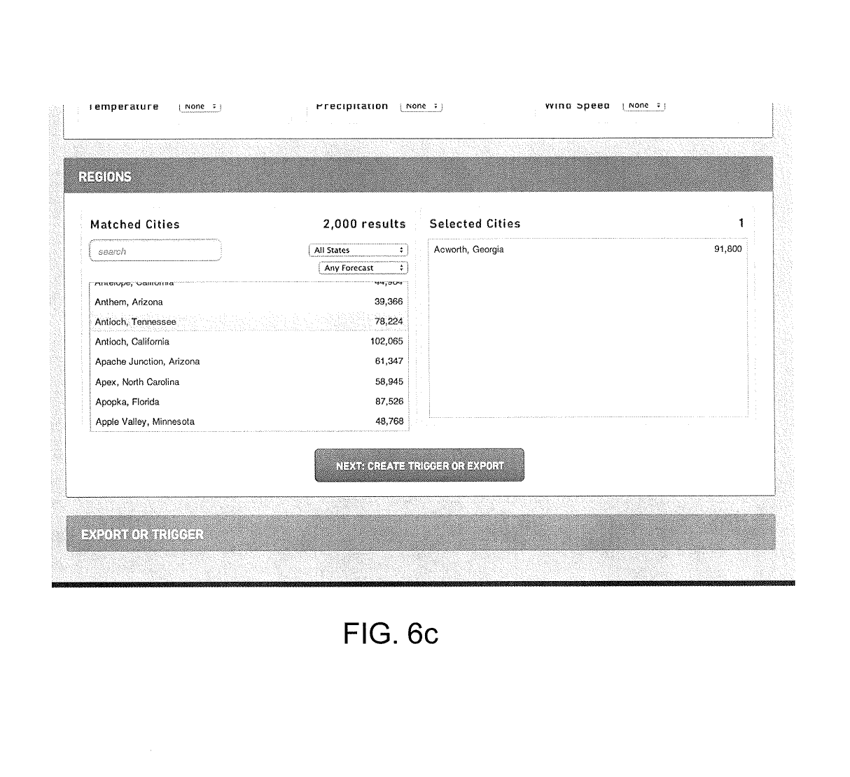

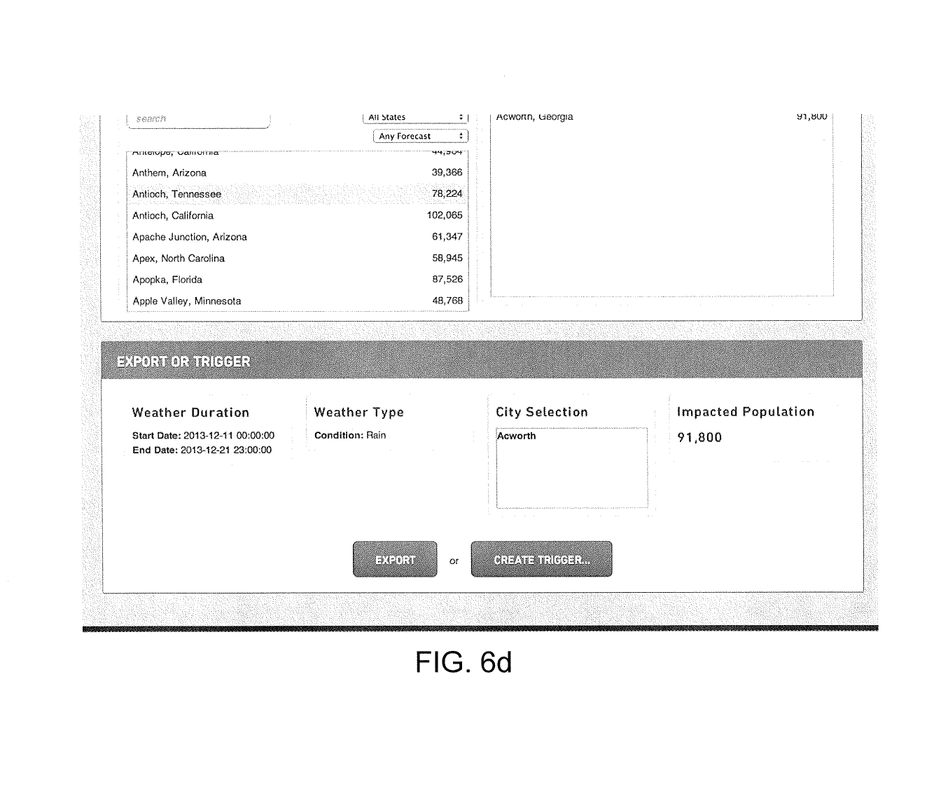

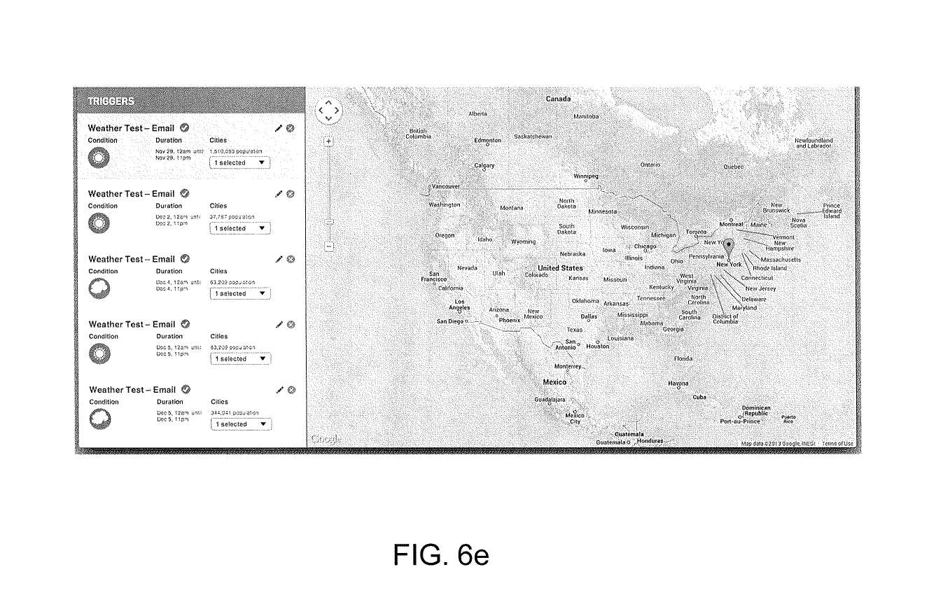

FIG. 6a-6e show sample screenshots of a sample use case of the method for sending email messages based on weather, in accordance with an aspect of the present invention. In the present aspect, a user is provided with options to create weather based triggers. FIG. 6a shows that the experience for the user begins by selecting the time duration to be for a weather trigger. The user can select start date and start time of the weather trigger. The user can then also select end date and end time of the weather trigger. In another aspect of the present invention, the available options for the start date include, Today (Current Time) and 10 days from now.

FIG. 6b shows that the user then selects weather conditions for the weather trigger. The user can select a weather type to base the weather trigger on. The weather type condition is selected from parameters that best suit the specific marketing campaign scope. In an aspect of the present invention, only one weather type can be selected. In another aspect of the present invention, multiple weather types can be selected. Examples of the available options for the weather type include:

Rain:
[Light/Heavy] Drizzle
[Light/Heavy] Rain
[Light/Heavy] Rain Mist
[Light/Heavy] Rain Showers

Snow:
[Light/Heavy] Snow
[Light/Heavy] Snow Grains
[Light/Heavy] Snow Showers
[Light/Heavy] Ice Crystals
[Light/Heavy] Ice Pellets
[Light/Heavy] Snow Blowing Snow Mist
[Light/Heavy] Low Drifting Snow
[Light/Heavy] Blowing Snow
[Light/Heavy] Ice Pellet Showers

Freezing Rain:
[Light/Heavy] Freezing Drizzle
[Light/Heavy] Freezing Rain

Hail:
[Light/Heavy] Hail
[Light/Heavy] Hail Showers
[Light/Heavy] Small Hail Showers
Small Hail

Fog/Mist/Smoke:
[Light/Heavy] Mist
[Light/Heavy] Fog
[Light/Heavy] Fog Patches
[Light/Heavy] Freezing Fog
Patches of Fog
Shallow Fog
Partial Fog

Thunderstorm:
[Light/Heavy] Thunderstorm
[Light/Heavy] Thunderstorms and Rain
[Light/Heavy] Thunderstorms and Snow
[Light/Heavy] Thunderstorms and Ice Pellets
[Light/Heavy] Thunderstorms with Hail
[Light/Heavy] Thunderstorms with Small Hail

Cloudy:
Partly Cloudy
Mostly Cloudy
Overcast
Scattered Clouds

Sunny:
Clear
Mostly Sunny
Partly Sunny

Volcanic Activity:

Funnel Cloud:

Hurricane:

In an aspect of the present invention, the weather type includes additional variables. The additional variables include one or more of temperature, precipitation and wind speed. In an aspect of the present invention, the temperature can be selected in at least one of ° F. and ° C. Further, the user can select a temperature which is one of greater than a pre-specified temperature, lesser than a pre-specified temperature, within a pre-specified temperature range and equal to a pre-specified temperature. In an aspect of the present invention, the user can specify the amount (snow/rain) of precipitation that must fall. The amount can be specified in one of percentage, millimetres (mm), centimetres (cm) and inches. In an aspect of the present invention, the user can specify wind speed. The wind speed can be specified in one of miles per hour (mph) and kilometres per hour (kmph).

FIG. 6c shows a location selections screen for the user. In an aspect of the present invention, a list of cities gets populated with population count, where the selected weather condition is present on the date range selected in FIG. 6a. The user can then select one or more cities. FIG. 6d shows that the user is then provided an ability to export its results or setup a trigger for an email message. In the present invention, the results are exported via .csv file. FIG. 6e shows that the user can associate a campaign with saved triggers. For examples:
a. Date Range—Wednesday August 26 (Current Time)-Thursday August 27 (EOD)
b. Weather Type—Sunny
c. Temperature>80 F
d. City: New York
e. Campaign Selected—Sunglass Sale New York
   The above trigger deploys a Sun Glass Sale Campaign to New York if the weather condition is sunny and temperature is greater than 80 degrees.

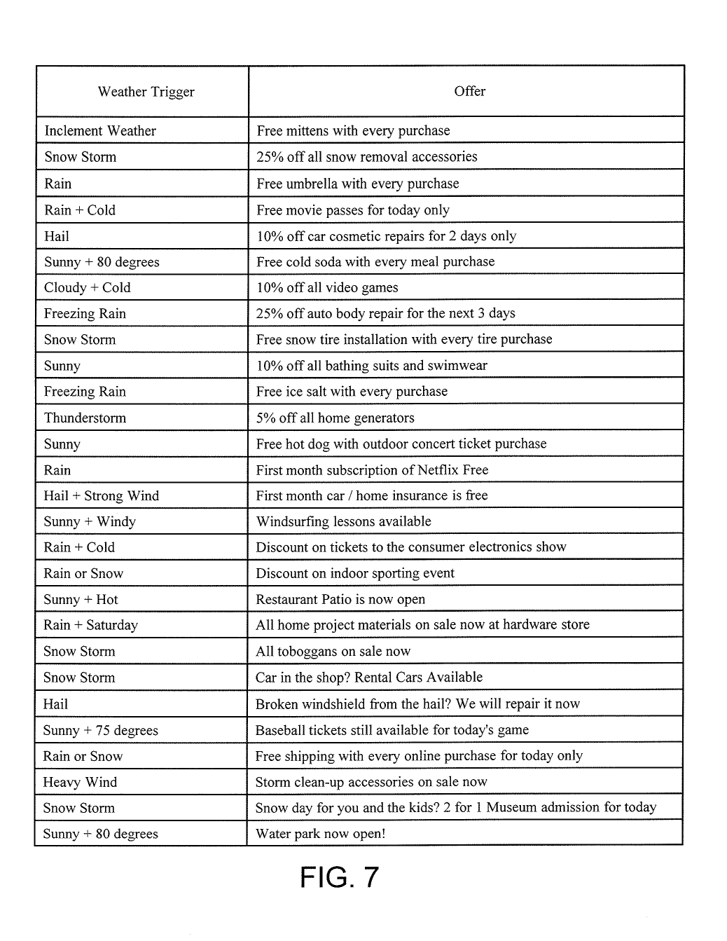

FIG. 7 shows a table containing examples of sample marketing messages triggered based on different weather triggers. In the present embodiment, the marketing messages are offers based on the weather conditions.

The computer program product of the invention is executable on a computer system for causing the computer system to perform a method for sending marketing messages by creating a trigger based on weather of the present invention. The computer system includes a microprocessor, an input device, a display unit and an interface to the Internet. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN, Wireless, GPRS, Ultrawide band and the Internet. The computer system facilitates inputs from a user through input device, accessible to the system through I/O interface.

The computer system executes a set of instructions that are stored in one or more storage elements, in order to process input data. The set of instructions may be a program instruction means. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the present invention has been described in connection with preferred aspects, it will be understood by those skilled in the art that variations and modifications of the preferred aspects described above may be made without departing from the scope of the invention. Other aspects will be apparent to those skilled in the art from a consideration of the specification or from a practice of the invention disclosed herein. It is intended that the specification and the described examples are considered exemplary only, with the true scope of the invention indicated by the following claims.

1. A method for transmitting marketing messages via a system connected to a plurality of devices via a network by creating a trigger based on weather, the method comprising:
initiating a set of conditions for sending one or more marketing messages;
adding one or more weather conditions to the set of conditions, the one or more weather conditions being selected by a user from a plurality of weather conditions;
providing one or more locations, the one or more locations having the added one or more weather conditions present;
adding at least one location of the one or more locations to the set of conditions, the at least one location being selected by the user;
associating the one or more marketing messages to the set of conditions;
providing user indicia indicating at least one of a start time and an end time for sending at least one marketing message of the one or more marketing messages, the user indicia being selected by the user;
transmitting, via the network, the at least one marketing message when the set of conditions are met; and
displaying the one or more marketing messages on a display device;
wherein the trigger comprises the set of conditions being met.

2. The method as recited in claim 1, further comprising:
adding a time duration of the trigger.

3. The method as recited in claim 2, wherein adding the time duration comprises selecting a start time of the trigger.

4. The method as recited in claim 2, wherein adding the time duration comprises selecting an end time of the trigger.

5. The method as recited in claim 1 further comprising:
adding user profile information to the set of conditions.

6. The method as recited in claim 5, wherein the user profile information comprises:
at least one of: an age group, a gender, interests, a work place and an income group.

7. The method as recited in claim 1, further comprising:
adding device profile information to the set of conditions, the at least one marketing message being transmitted to devices matching the added device profile information.

8. The method as recited in claim 5, wherein the device profile information comprises one or more of: an operating system (OS), an operative system version, a device manufacturer, a device model, a device network and a device screen resolution.

9. The method as recited in claim 1, wherein the plurality of weather conditions comprises one or more of: a weather type, a temperature, precipitation, humidity and wind speed.

10. The method as recited in claim 9, wherein the weather type is at least one of: rain, snow, freezing rain, hail, fog, mist, smoke, thunderstorm, cloudy, sunny, volcanic activity, hurricane and funnel cloud.

11. The method as recited in claim 1, wherein the at least one marketing message is one or more of: an offer, an advertisement, a promotion and a discount.

12. The method as recited in claim 1, wherein the at least one marketing message is transmitted via at least one of: an email, a Short Messaging Service (SMS) message, a push notification, a data message, a website, a web page, a Multimedia Messaging Service (MMS) message, Unstructured Supplementary Service Data (USSD) service, a voice call and a multimedia call.

13. The method as recited in claim 1, wherein associating the one or more marketing messages comprises composing the one or more marketing messages.

14. The method as recited in claim 1 further comprising:
displaying a total number of users or devices matching the set of conditions.

15. The method as recited in claim 1 further comprising:
exporting the set of conditions to a file.

16. (canceled)

17. A system connected to a plurality of devices via a network for sending marketing messages by creating a trigger based on weather, the system comprising:
a setup module, the setup module initiating a set of conditions for sending one or more marketing messages;
a weather module, the weather module adding one or more weather conditions to the set of conditions, the one or more weather conditions being selected by a user from a plurality of weather conditions;
a display module, the display module providing one or more locations, the one or more locations having the added one or more weather conditions present;
a location module, the location module adding at least one location of the one or more locations to the set of conditions, the at least one location being selected by the user;
an association module, the association module associating the one or more marketing messages to the set of conditions;
a schedule module, the schedule module providing user indicia indicating at least one of a start time and an end time for sending at least one marketing message of the one or more marketing messages, the user indicia being selected by the user;
a message module, the message module transmitting, via the network, the at least one marketing message when the set of conditions are met; and
a display device, displaying the one or more marketing messages;
wherein the trigger comprises the set of conditions being met.

18. The system as recited in claim 17 further comprising:
a schedule module, the schedule module adding a time duration of the trigger.

19. The system as recited in claim 18, wherein the schedule module comprises:
a start schedule module for selecting a start time of the trigger.

20. The system as recited in claim 18, wherein the schedule module comprises:
an end schedule module for selecting an end time of the trigger.

21. The system as recited in claim 17 further comprising:
a user profile module, the user profile module adding user profile information to the set of conditions.

22. The system as recited in claim 21, wherein the user profile information comprises one or more of: an age group, a gender, interests, a work place and an income group.

23. The system as recited in claim 17, further comprising:
a device information module, the device information module adding device profile information to the set of conditions.

24. The system as recited in claim 23, wherein the device profile information comprises one or more of: an operating system (OS), an operative system version, a device manufacturer, a device model, a device network and a device screen resolution.

25. The system as recited in claim 17, wherein the plurality of weather conditions comprises one or more of: a weather type, a temperature, precipitation, humidity and wind speed.

26. The system as recited in claim 25, wherein the weather type is at least one of: rain, snow, freezing rain, hail, fog, mist, smoke, thunderstorm, cloudy, sunny, volcanic activity, hurricane and funnel cloud.

27. The system as recited in claim 17, wherein the at least one marketing message is one or more of: an offer, an advertisement, a promotion and a discount.

28. The system as recited in claim 17, wherein the at least one marketing message is transmitted via at least one of: an email, a Short Messaging Service (SMS) message, a push notification, a data message, a website, a web page, a Multimedia Messaging Service (MMS) message, Unstructured Supplementary Service Data (USSD) service, a voice call and a multimedia call.

29. The system as recited in claim 17 further comprising:
a user number module, the user or device number module displaying a total number of users or devices matching the set of conditions.

30. A computer program product comprising a non-transitory computer usable medium having control logic stored therein for causing a device having a processor to transmit marketing messages by creating a trigger based on weather, the control logic comprising:
computer readable program code means for initiating a set of conditions for sending one or more marketing messages;
computer readable program code means for adding one or more weather conditions to the set of conditions, the one or more weather conditions being selected by a user from a plurality of weather conditions;
computer readable program code means for providing one or more locations, the one or more locations having the added one or more weather conditions present;
computer readable program code means for adding at least one location of the one or more locations to the set of conditions, the at least one location being selected by the user;
computer readable program code means for associating the one or more marketing messages to the set of conditions;
computer readable program code means for providing user indicia indicating at least one of a start time and an end time for sending at least one marketing message of the one or more marketing messages, the user indicia being selected by the user;
computer readable program code means for transmitting, via a network, the at least one marketing message when the set of conditions are met; and
computer readable program code means for displaying the one or more marketing messages on a display device;
wherein the trigger comprises the set of conditions being met.

31. The method of claim 1, further comprising:
saving the set of conditions; and
transmitting, via the processor, another one of the one or more marketing messages, the another marketing message being transmitted when the saved set of conditions are met;
wherein the trigger comprises the saved set of conditions being met.
